(19) United States
(12) Patent Application Publication
(10) Pub. No.: US 2012/0157349 A1
(43) Pub. Date: Jun. 21, 2012

(54) CELL CHIP PACKAGE

(75) Inventors: Jeong Suong YANG, Seoul (KR); Bo Sung Ku, Suwon (KR)

(73) Assignee: SAMSUNG ELECTRO-MECHANICS CO., LTD.

(21) Appl. No.: 13/159,910

(22) Filed: Jun. 14, 2011

(30) Foreign Application Priority Data
Dec. 21, 2010 (KR) 10-2010-0131694

(51) Int. Cl. C40B 60/12

(52) U.S. Cl. 506/39

(57) ABSTRACT

There is provided a cell chip package, including: a chamber having an opening formed in a region thereof; a cell chip received in an inside of the chamber and having a biomaterial array formed therein; and a sealing membrane mounted in the opening and made of a gas permeable material. The cell chip package may facilitate experimentation and long-term storage with respect to a cell chip.

### CROSS-REFERENCE TO RELATED APPLICATIONS

This application claims the priority of Korean Patent Application No. 10-2010-0131694 filed on Dec. 21, 2010, in the Korean Intellectual Property Office, the disclosure of which is incorporated herein by reference.

### BACKGROUND OF THE INVENTION

1. Field of the Invention

The present invention relates to a cell chip package, and more particularly, to a cell chip package facilitating experimentation and storage with respect to a cell chip.

2. Description of the Related Art

The demand for biomedical devices and biotechnology for rapidly diagnosing various human diseases has recently increased. Accordingly, the development of a biosensor or a biochip capable of rapidly providing diagnostic results for a specific disease, requiring a lengthy process in a hospital or a research laboratory, has been actively conducted.

Research into a biosensor or a biochip has been conducted in pharmaceutical companies, cosmetics companies, and the like, in addition to hospitals. In the fields of pharmaceuticals, cosmetics, and the like, a method of verifying the effectiveness and stability (toxicity) of a specific drug by testing the reaction of a cell thereto has been used. Since, in the method according to the related art, animals or a large amount of reagent should be used, increases of cost and time are caused.

Accordingly, there is a need for the development of a biosensor or a biochip capable of rapidly and accurately diagnosing diseases while simultaneously allowing for a reduction in cost.

The biochip may be divided into a DNA chip, a protein chip, and a cell chip according to the kinds of biomaterials fixed to a substrate. In the early stage, as the understanding of human genetic information has increased, the DNA chip has been prominent. However, as the interest in proteins maintaining vital activity and in a cell, which is protein conjugate and becomes the core of living things, has increased, interest in a protein chip and a cell chip has correspondingly increased.

The protein chip initially had a difficulty such as non-selective adsorption. However, methods for solving the difficulty have been recently suggested.

The cell chip, which is an effective medium applicable to various fields such as the development of new medicines, genomics, proteomics, and the like, has been prominent.

### SUMMARY OF THE INVENTION

An aspect of the present invention provides a cell chip package facilitating experimentation and storage with respect to a cell chip.

According to an aspect of the present invention, there is provided a cell chip package including: a chamber having an opening formed in one region thereof; a cell chip received in an inside of the chamber and having a biomaterial array formed therein; and a sealing membrane mounted in the opening and made of a gas permeable material.

The sealing membrane may be made of polydimethylsiloxane, polyimide, polyvinyl chloride, polyurethane, or a copolymer thereof.

The chamber may be configured of a lower chamber having a receiving space formed therein and an upper cover mounted on the lower chamber to cover the receiving space.

The chamber may be configured of a lower chamber having a receiving space formed therein and an upper cover mounted on the lower chamber to cover the receiving space, and the opening may be formed in the upper cover.

The chamber may be configured of a lower chamber having a receiving space formed therein and an upper cover mounted on the lower chamber to cover the receiving space, and the upper cover may be mounted on the lower chamber by a screw.

A gasket may be disposed between the lower chamber and the upper cover.

The chamber may have at least one groove formed therein.

The cell chip may include: a first substrate having the biomaterial array formed thereon; and a second substrate having a plurality of grooves formed therein, the plurality of grooves corresponding to the biomaterial array and having samples injected thereinto.

The cell chip package may further include a permeable membrane formed in the vicinity of a biomaterial and made of a gas permeable material.

The permeable membrane may be made of polydimethylsiloxane, polyimide, polyvinyl chloride, polyurethane, or a copolymer thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view showing a cell chip package according to an exemplary embodiment of the present invention;

FIG. 1B is a schematic cross-sectional view showing the cell chip package taken along line I-I′ of FIG. 1A;

FIG. 2A is a schematic cross-sectional view showing a cell chip according to an exemplary embodiment of the present invention;

FIG. 2B is a schematic cross-sectional view showing a first substrate of the cell chip shown in FIG. 2A; and

FIG. 2C is a schematic cross-sectional view showing a second substrate of the cell chip shown in FIG. 2A.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

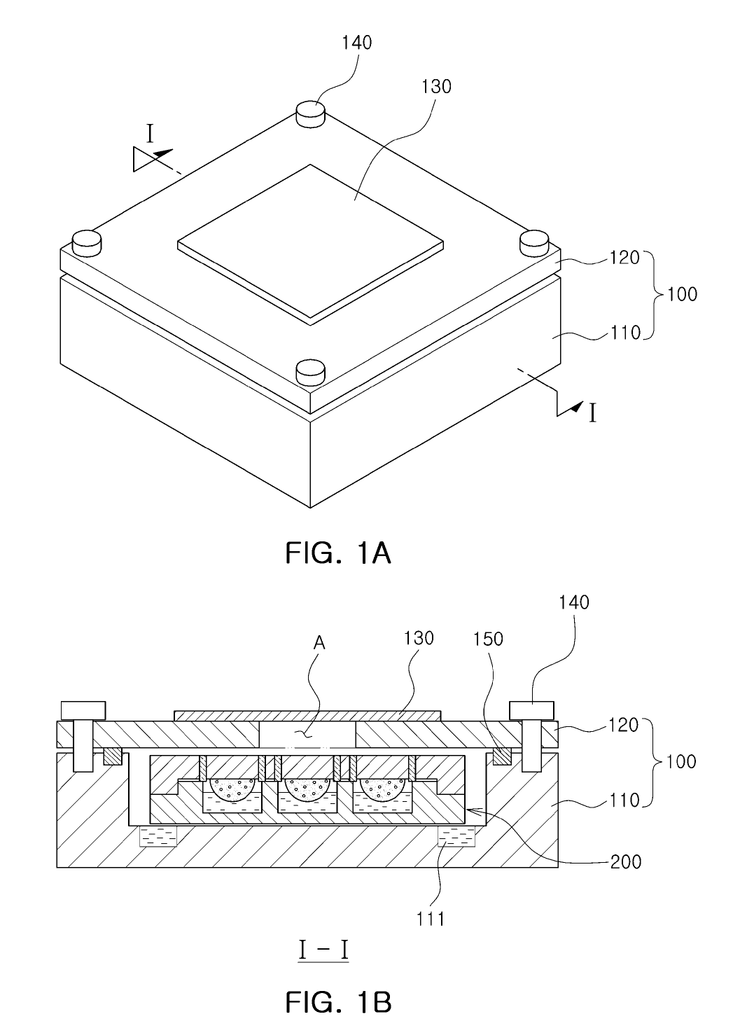

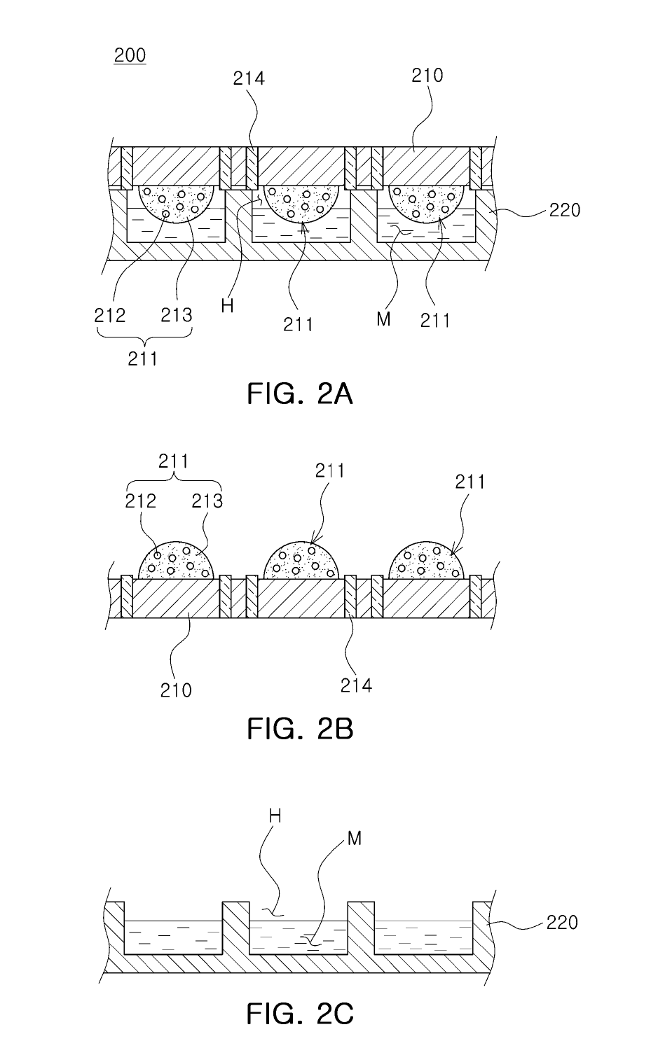

FIG. 1A is a schematic perspective view showing a cell chip package according to an exemplary embodiment of the present invention, and FIG. 1B is a schematic cross-sectional view showing the cell chip package taken along line I-I′ of FIG. 1A. FIG. 2A is a schematic cross-sectional view showing a cell chip according to an exemplary embodiment of the present invention, FIG. 2B is a schematic cross-sectional view showing a first substrate of the cell chip shown in FIG. 2A, and FIG. 2C is a schematic cross-sectional view showing a second substrate of the cell chip shown in FIG. 2A.

Referring to FIGS. 1A and 1B, a cell chip package according to an exemplary embodiment of the present invention includes a chamber 100 having an opening formed in one region thereof, and a cell chip 200 received in an inside of the chamber. Herein, a structure having an internal space is defined as a chamber.

The chamber 100 may include a lower chamber 110 having a receiving space formed in an inside thereof, and an upper cover 120 covering the receiving space.

The cell chip is disposed in the receiving space of the lower chamber, and the upper cover is mounted on the lower chamber, whereby the cell chip package may be easily manufactured.

The cell chip 200 may be received in the receiving space of the lower chamber 110, and the upper cover 120 may be mounted on the lower chamber 100 to cover the receiving space.

The upper cover 120 may have an opening A through which air including carbon dioxide and vapor may be supplied to the cell chip 200.

The opening according to the present exemplary embodiment is formed in the upper cover; however, a position of the opening is not limited thereto. The opening may be formed in other region of the chamber.

The chamber may be made of a material such as glass, metal, plastic, and the like; however, a material of the chamber is not limited thereto.

A sealing membrane 130 may be mounted on the opening A, and may be made of a gas permeable material.

The sealing membrane 130 made of the gas permeable material may allow air and vapor to permeate therethrough, and the amount of air and vapor supplied to the inside of the chamber may be controlled thereby.

As the gas permeable material, there may be, for example, polydimethylsiloxane (PDMS), polyimide, polyvinyl chloride, polyurethane, or a copolymer thereof; however, the gas permeable material is not limited thereto.

The upper cover 120 may be connected to the lower chamber by a screw 140. In addition, a gasket 150 may be disposed between the upper cover 120 and the lower chamber 110. The gasket may be made of rubber; however, a material of the gasket is not limited thereto.

The gasket 150 may prevent the air and the vapor from leaking through a space between the upper cover 120 and the lower chamber 110, and the sealing membrane 130 may control the permeation of the air and the vapor.

Accordingly, the cell chip may be stored for a long time, and the optimal conditions may be maintained during various experimentations with respect to the cell chip.

In addition, the lower chamber 110 may have at least one groove 111, which may receive water, or the like. A condition such as humidity, or the like, of the lower chamber may be controlled by the water received in the groove.

The size of the groove 111 is not specifically limited, and may be, for example, 50 to 200 μl.

Referring to FIGS. 2A through 2C, the cell chip according to the present exemplary embodiment includes a first substrate 210 and a second substrate 220, and may have a structure in which the first and second substrates are coupled to each other.

A biomaterial array is formed on the first substrate 210. The biomaterial array may be formed in a matrix shape.

The first substrate 110 is not specifically limited so long as it may have a biomaterial formed thereon, and may be made of, for example, silicon, glass, metal, or a polymer; however, a material of the first substrate is not limited thereto.

The polymer substrate may be made of, for example, polymethacrylate (PMMA), polycarbonate (PC), polystyrene (PS), maleic anhydride, cyclic olefin copolymer, polynorbonene, styrene-butadiene copolymer (SBC), or acrylonitrile butadiene styrene, or a copolymer thereof; however, a material of the polymer substrate is not limited thereto.

A plurality of biomaterials 211 having a predetermined size are arranged at a predetermined interval on the first substrate 210.

The biomaterial 211 may have a shape in which cells are dispersed in a cell dispersion material.

In the present exemplary embodiment, the biomaterial has a droplet shape, and the cells 212 are dispersed within the cell dispersion material 213. The kind of the cells 212 is not specifically limited, and may be, for example, a microorganism, a plant and animal cell, a tumor cell, a neural cell, an endovascular cell, or an immune cell.

The cell dispersion material 213 is not specifically limited so long as it allows a cell function to be maintained, and may be made of a porous material. The cell dispersion material 213 is made of the porous material to allow cell culture media, a specific drug, various aqueous solutions, and the like to permeate therethrough.

The cell 212 may maintain a tissue and a function thereof by the cell dispersion material 213.

The cell dispersion material 213 may be, for example, sol-gel, hydro gel, alginate gel, organogel or xerogel, gelatin or collagen; however, the cell dispersion material is not limited thereto.

Permeable membranes 214 are formed in the vicinity of each of the biomaterials 211. Grooves are formed in the first substrate 210 in the vicinity of the biomaterials 211, and the permeable membranes 214 are injected thereinto.

The permeable membrane may be made of a gas permeable material. The gas permeable material may be, for example, polydimethylsiloxane (PDMS), polyimide, polyvinyl chloride, polyurethane, or a copolymer thereof; however, the gas permeable material is not limited thereto.

The second substrate 220 may have a plurality of grooves H formed therein, and a sample M may be injected into each of the grooves H. The grooves H formed in the second substrate 220 may correspond to positions of the biomaterials 211 formed on the first substrate 210, and the biomaterials 211 formed on the first substrate 210 may be injected thereinto.

The sample M is not specifically limited, and may be, for example, cell culture media, a specific drug, or various aqueous solutions.

In order to maintain the function of the cell, the culture media should be continuously supplied thereto. According to the present exemplary embodiment, the culture media is injected into the groove H of the second substrate 220 and the second substrate is coupled to the first substrate, and thus the culture media may be supplied to the biomaterial 211 formed on the first substrate.

In addition, in order to perform diagnosis for a specific drug, the specific drug may be injected into the groove H of the second substrate 220, and be supplied to the biomaterial 211.

By supplying a specific drug to a biomaterial, a toxicity test, an anti-cancer agent sensitivity and resistivity test, or the like, for the development of new medicines may be performed.

According to the present exemplary embodiment, when the first substrate 210 is coupled to the second substrate 220, the permeable membranes 214 of the first substrate are positioned in the vicinity of the grooves of the second substrate 220. The permeable membranes 214 allow air including carbon dioxide to be supplied to the biomaterial and prevent the evaporation of the sample M.

Accordingly, the carbon dioxide may be evenly supplied, and the evaporation of the sample is prevented, whereby apoptosis may be prevented.

As set forth above, the cell chip package according to exemplary embodiments of the present invention includes a chamber having an opening formed therein, and a sealing membrane made of a gas permeable material is mounted on the opening. The sealing membrane may allow air and vapor to permeate therethrough and the amount of air and vapor supplied to the inside of the chamber may be controlled by the sealing membrane.

In addition, the chamber may be configured of a lower chamber and an upper cover, and a gasket may be disposed between the upper cover and the lower chamber. The gasket may prevent air and vapor from being leaked through a space between the upper cover and the lower chamber, and the permeated amount of air and vapor may be controlled by the sealing membrane.

Further, a cell chip according to exemplary embodiments of the present invention may be configured of first and second substrates. A permeable membrane is provided in the first substrate, whereby air including carbon dioxide may be supplied to a biomaterial and the evaporation of a sample may be prevented.

Accordingly, experimentations and long-term storage with respect to the cell chip may be facilitated.

While the present invention has been shown and described in connection with the exemplary embodiments, it will be apparent to those in the art that modifications and variations can be made without departing from the spirit and scope of the invention as defined by the appended claims.

What is claimed is:

1. A cell chip package comprising:
a chamber having an opening formed in one region thereof;
a cell chip received in an inside of the chamber and having a biomaterial array formed therein; and
a sealing membrane mounted in the opening and made of a gas permeable material.

2. The cell chip package of claim 1, wherein the sealing membrane is made of polydimethylsiloxane, polyimide, polyvinyl chloride, polyurethane, or a copolymer thereof.

3. The cell chip package of claim 1, wherein the chamber is configured of a lower chamber having a receiving space formed therein and an upper cover mounted on the lower chamber to cover the receiving space.

4. The cell chip package of claim 1, wherein the chamber is configured of a lower chamber having a receiving space formed therein and an upper cover mounted on the lower chamber to cover the receiving space, and the opening is formed in the upper cover.

5. The cell chip package of claim 1, wherein the chamber is configured of a lower chamber having a receiving space formed therein and an upper cover mounted on the lower chamber to cover the receiving space, and the upper cover is mounted on the lower chamber by a screw.

6. The cell chip package of claim 3, wherein a gasket is disposed between the lower chamber and the upper cover.

7. The cell chip package of claim 4, wherein a gasket is disposed between the lower chamber and the upper cover.

8. The cell chip package of claim 5, wherein a gasket is disposed between the lower chamber and the upper cover.

9. The cell chip package of claim 1, wherein the chamber has at least one groove formed therein.

10. The cell chip package of claim 1, wherein the cell chip includes:
a first substrate having the biomaterial array formed thereon; and
a second substrate having a plurality of grooves formed therein, the plurality of grooves corresponding to the biomaterial array and having samples injected thereinto.

11. The cell chip package of claim 10, further comprising a permeable membrane formed in the vicinity of a biomaterial and made of a gas permeable material.

12. The cell chip package of claim 11, wherein the permeable membrane is made of polydimethylsiloxane, polyimide, polyvinyl chloride, polyurethane, or a copolymer thereof.
